(19) United States
(12) Patent Application Publication
(10) Pub. No.: US 2014/0014073 A1
(43) Pub. Date: Jan. 16, 2014

(54) DEACTIVATABLE FUEL PUMP FOR SUPPLYING SUCTION JET PUMPS

(71) Applicant: Robert Bosch GmbH, Stuttgart (DE)

(72) Inventors: Karsten Scholz, Schwieberdingen (DE); Andreas Posselt, Muehlacker (DE); Marko Lorenz, Grossbottwar (DE)

(21) Appl. No.: 13/939,770

(22) Filed: Jul. 11, 2013

(30) Foreign Application Priority Data
Jul. 11, 2012 (DE) 10 2012 212 049.1

(51) Int. Cl. F02M 39/00

(52) U.S. Cl. CPC F02M 39/005
USPC 123/495

(57) ABSTRACT

A system for supplying fuel to an internal combustion engine. The system comprises a first fuel pump, which is designed to deliver fuel from a reservoir to the internal combustion engine. The system furthermore comprises a suction jet pump which is designed to fill the reservoir with fuel. In addition, the system comprises a second fuel pump which is designed to operate the suction jet pump. The system furthermore comprises a control unit which is designed to operate the second fuel pump if a fuel fill level falls below a predefinable threshold value.

### BACKGROUND OF THE INVENTION

Fuel delivery devices, which supply fuel to an internal combustion engine, such as, for example a CI engine, can be provided in fuel tanks, for example in motor vehicles. A fuel delivery device is, for example, known from the German patent application DE 10 2010 039 547 A1.

The fuel delivery device can thereby have a reservoir which is initially filled with fuel. The fuel in the reservoir is subsequently delivered to the internal combustion engine. The reservoir can be filled with the aid of a suction jet pump. To this end, the suction jet pump requires motor fuel as a pump fluid. The fuel can thereby be delivered, for example, directly from a fuel pump which supplies the internal combustion engine. Alternatively the fuel can be provided from a return flow, i.e. from excess fuel that has been delivered to the combustion engine.

In so doing, the fuel is continuously provided to the suction jet pump, and therefore the suction jet pump continuously fills the reservoir with fuel.

A need may exist for an improved system and an improved method for supplying an internal combustion engine with fuel, which particularly make it possible to save energy.

### SUMMARY OF THE INVENTION

Features, details and possible advantages of a device according to embodiments of the invention are discussed below in detail.

According to a first aspect of the invention, a system for providing fuel to an internal combustion engine is presented. The system comprises a first fuel pump, a second fuel pump, a suction jet pump and a control unit. The first fuel pump is designed to deliver fuel from a reservoir to the internal combustion engine. The suction jet pump is designed to fill the reservoir with fuel from the fuel tank in which the reservoir is disposed. The second fuel pump is designed to operate the suction jet pump, i.e. to supply fuel as the pump fluid to said suction jet pump. In addition, the control unit is designed to only operate the second fuel pump if a fuel fill level falls below a predefinable threshold value.

In other words, the concept of the present invention is based on providing an additional second fuel pump in the reservoir for operating the suction jet pump. The fuel pump is thereby designed to be deactivatable and is only available for operating the suction jet pump. In so doing, the second fuel pump is only operated as required. That means that the suction jet pump is only then operated with the aid of a control unit if the tank fill level falls below a predefined value.

By the use of an additional fuel pump, namely the second fuel pump, the fuel supply to high-performance internal combustion engines can be ensured. In addition, energy can be saved by operating the second fuel pump only as needed because the energy for generating the fuel quantity for the suction jet pump is used only as required.

The system can, for example, be used in fuel tanks of motor vehicles and embodied as a fuel delivery device. The system has, for example, a reservoir which can also be denoted as a storage pot. The reservoir is positioned, for example, close to the bottom of the fuel tank and can be pressed to the bottom of the fuel tank via guide bars and if necessary springs. An opening can be provided on the bottom of the reservoir which can be closed by a valve. The suction jet pump can be provided above the opening. The suction jet pump then comprises a drive pipe also referred to as a feeder pipe. In addition, the suction jet pump comprises a nozzle and a mixer duct. If the fuel as pump fluid enters the mixer duct through a small opening of the nozzle, a drop in pressure results so that fuel from the fuel tank is drawn by suction through the valve in the bottom of the reservoir.

The first fuel pump and the second fuel pump can likewise be provided directly in the reservoir. In so doing, the first and the second fuel pump can, for example, be electric fuel pumps or mechanical fuel pumps. The second fuel pump is thereby embodied independently of, or rather separately from, the first fuel pump. In so doing, the first fuel pump can, for example, deliver fuel in a continuous operation, i.e., for example, in a permanent operation, from the reservoir to the internal combustion engine. An excess of fuel can, for example, be guided back into the reservoir via a return line. The second fuel pump is not operated continuously but only when required. In so doing, the second fuel pump pumps fuel as pump fluid to the suction jet pump or to a plurality of suction jet pumps, which in turn draw fuel by suction out of the fuel tank and into the reservoir during the operation of the second fuel pump.

A control unit can determine when the second fuel pump is to operate, i.e. is to be supplied with fuel. The control unit can thereby, for example, comprise a processor and a storage unit. The control unit can thus be embodied as an engine control device or a pump control device. In particular, the control device can be directly associated with the second fuel pump or alternatively control a plurality of processes within the system. The control device is thus embodied to ascertain or acquire a current fuel fill level and to compare the same to a predefined threshold value. In this case, the threshold value can, for example, be stored in a storage unit of the control unit. If the fuel fill level currently ascertained lies below the predefined threshold value, the control unit then controls the second fuel pump in such a manner that said second fuel pump delivers pump fluid to the suction jet pump and thus operates the same. In other words, the control unit controls the second fuel pump such that said pump pumps fuel into the reservoir as soon as the fuel fill level falls below a certain value. The fuel fill level can thereby be ascertained at different locations in the fuel tank. The fuel fill level can, for example, be ascertained directly in the fuel tank or directly in the reservoir.

The control unit can be disposed within the reservoir or within the fuel tank or outside of the reservoir and if need be outside of the fuel tank.

According to one exemplary embodiment of the invention, the system has a first fill level measuring device. The first fill level measuring device is designed to ascertain the fuel fill level in the fuel tank in which the system is disposed. The first fill level measuring device is furthermore designed to transmit the ascertained fuel fill level to the control unit. In this exemplary embodiment, a tank fill level is ascertained as the fuel fill level. To this end, the first fill level measuring device can comprise a float and a potentiometer.

According to a further exemplary embodiment of the invention, the system comprises a second fill level measuring device which is designed to ascertain the fuel fill level in the reservoir. In addition, the second fill level measuring device is designed to transmit the ascertained fuel fill level to the control unit. In this case, the fuel fill level is ascertained as the reservoir fill level and is supplied to the control unit. To this end, the second fill level measuring device can be designed as a contact switch or as a reed contact or, respectively, as a reed switch. In an advantageous manner, the second fill level measuring device can be disposed directly in the upper region, in particular at the upper edge of the reservoir.

The first and the second fill level measuring devices can be designed as part of the system or, respectively, as part of the fuel delivery device. The first and the second fill level measuring devices can alternatively be embodied separately from the system and can communicate with said system, in particular with the control unit, in a wireless or wire-connected manner. In so doing, the system can comprise only a first fill level measuring device or only a second fill level measuring device. Alternatively the first as well as the second fill level measuring device can be provided or more precisely integrated in the system. If provision is made for both fill level measuring devices in the system, the fuel fill level in the fuel tank as well as the fuel fill level in the reservoir of the control unit can be made available. In this way, the control unit can determine even more exactly the necessity for operating the second fuel pump and thereby for drawing fuel by suction out of the fuel tank and into the reservoir; thus enabling where necessary energy to be additionally saved.

According to a further exemplary embodiment of the invention, the first fill level measuring device is designed to continuously ascertain the fuel fill level and if need be to continuously transmit said fuel fill level to the control unit. Additionally or alternatively, the second fill level measuring device is designed to continuously ascertain the fuel fill level in the reservoir and if need be to continuously transmit said fuel fill level to the control unit. Alternatively, the first as well as the second fill level measuring device can be designed to ascertain the respective fuel fill level in the fuel tank and in the reservoir at a predefined point in time or, respectively, in predefined time intervals and to transmit said fuel fill level to the control unit.

According to a further exemplary embodiment of the invention, the control unit is designed to compare the ascertained fuel fill level to the predefined threshold value. A plurality of threshold values can thereby be predefined. Particularly if the first fill level measuring device as well as the second fill level measuring device transmits the ascertained values to the control unit, a first threshold value and a second threshold value can be provided in the control unit. In particular, the threshold values provided in the control unit for the fuel fill level in the fuel tank and for the fuel fill level in the reservoir can be different.

According to a further exemplary embodiment of the invention, the control unit is embodied as an engine control unit or as a pump control unit.

According to a second aspect of the invention, a method for operating one of the systems depicted above is described. The method can, for example, be carried out by a control unit and comprises the following steps: actuating a first fuel pump for the delivery of fuel from a reservoir to an internal combustion engine; ascertaining a fuel fill level and comparing said fuel fill level to a predefinable threshold value by means of a control unit; actuating a second fuel pump for operating a suction jet pump if the fuel fill level lies below the threshold value.

### BRIEF DESCRIPTION OF THE DRAWING

Further features and advantages of the present invention will become apparent to the person skilled in the art by means of the following description of exemplary embodiments with reference to the attached drawing. Said features and advantages are, however, not to be interpreted so as to limit the invention.

FIG. 1 shows a cross-section of a system according to one exemplary embodiment of the invention.

### DETAILED DESCRIPTION

The FIGURE is only a schematic depiction of the inventive device or, respectively, the components thereof according to one exemplary embodiment of the invention. Particularly distances between components and size relationships are not reflected in the FIGURE true to scale. Elements which correlate to one another are provided with the same reference numbers.

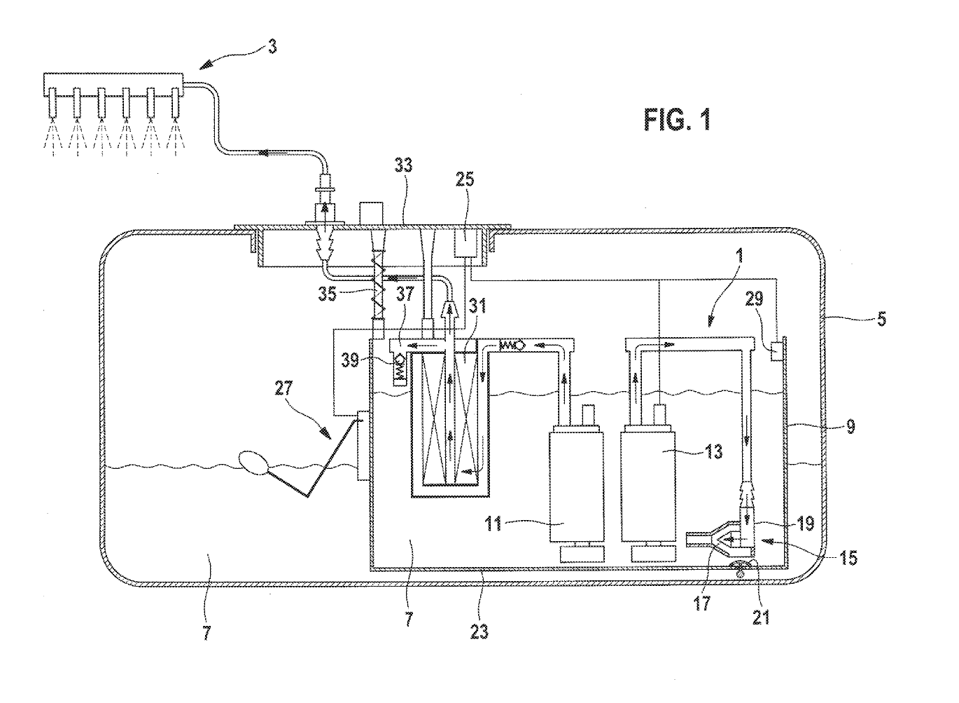

In FIG. 1, the inventive system 1 is depicted in a fuel tank 5. The system 1 comprises a first fuel pump 11, a second fuel pump 13, a suction jet pump 15 and a control unit 25. The first fuel pump 11 supplies fuel 7 to an internal combustion engine 3 arranged outside of the fuel tank 5. A filter 31 can be provided between the first fuel pump 11 and the internal combustion engine 3. In this case, the first fuel pump 11, for example, continuously delivers fuel 7 to the internal combustion engine 3. The excess fuel can thereby be delivered via an overflow line 37 and if need be via a pressure regulating valve 39 back into the fuel tank 5 and in particular into a reservoir 9 disposed therein.

The system 1 further comprises the reservoir 8 in which the first fuel pump 11, the second fuel pump 13 and the suction jet pump 15 are disposed. The reservoir 9 can, for example, be inserted into the fuel tank 5 via a tank flange 33 and be pressed against the bottom of the fuel tank 5 via one or a plurality of guide bars 35. Springs can be provided on the guide bars 35. Alternatively, the reservoir can be directly attached to the bottom of the fuel tank 5.

The suction jet pump 15 is disposed in the proximity of the bottom 23 of the reservoir 9. The suction jet pump 15 thereby comprises a nozzle 17 and a supply line 19 which is supplied with fuel 7 as the pump fluid with the aid of the second fuel pump 13. An opening, which can be closed by a valve 21, is located on the nozzle 17 at the bottom 23 of the reservoir 19. If fuel 7 as pump fluid moves through the opening of the nozzle 17 into a mixer duct, a drop in pressure occurs at the nozzle; thus enabling the valve 21 to open and fuel 7 to flow, respectively to be drawn, from the fuel tank 5 into the reservoir 9. In the process, the second fuel pump 13 is, however, not operated continuously but delivers fuel 7 to the supply line 19 of the suction jet pump 15 only as required.

The need is thereby ascertained with the aid of the control unit 25. The control unit 25 is disposed on the tank flange 33 in the depicted exemplary embodiment. The control unit 24 can alternatively be disposed directly on the second fuel pump 13 or outside of the fuel tank 5. The control unit is designed to ascertain the fuel fill level. To this end, said control unit 25 is connected to a first fill level measuring device 27 and to a second fill level measuring device 29 in the depicted exemplary embodiment. As an alternative thereto, only one of the fill level measuring devices 27, 29 can be provided in the system 1. The first fill level measuring device 27 is disposed outside of the reservoir 9 and is embodied as a float with a potentiometer. In so doing, said first fill level measuring device 27 is designed to ascertain a fuel fill level directly in the fuel tank 5. The second fill level measuring device 29 is disposed directly in the reservoir 9 and is embodied as a contact switch. In particular, the second fill level measuring device 29 is disposed in the upper region of the reservoir 9. Said second fill level measuring device 29 thus ascertains the fuel fill level directly in the reservoir. The fuel fill level in the fuel tank 5 and the fuel fill level in the reservoir 9 can vary as is shown in FIG. 1.

The control unit 25 is, for example, connected via cable or alternatively in a wireless manner to the second fuel pump 13, the first fill level measuring device 27 and the second fill level measuring device 29. The fill level measuring devices 27, 29 deliver measurement values to the control unit 25 continuously or at certain time intervals. Said control unit evaluates the transmitted fuel fill levels by comparing said fill levels with predefined threshold values. In particular, a fuel fill level which was ascertained in the fuel tank 5 is compared with the first threshold value. In addition, a fuel fill level ascertained in the reservoir 9 is compared with a second threshold value. If one or even both ascertained fuel fill levels lies below the respective threshold, the control unit 25 then actuates the second fuel pump 13 to pump fuel 7 to the suction jet pump 15 and thereby operates said suction jet pump to fill the reservoir 9.

In this way, the second fuel pump 13 is only switched on as required and is operated, for example, only when the fuel fill level in the fuel tank is low. In so doing, energy is saved. Through the use of the second fuel pump 13, a reliable fuel supply can furthermore be ensured even to high performance internal combustion engines 3.

In closing, it should be noted that expressions such as “comprise” or something similar like “have” should not exclude that further elements or steps can be provided. It should furthermore be pointed out that “one” or “a” does not exclude the use of a plurality of some component. In addition, features described in connection with the different embodiments can be arbitrarily combined with one another. It is additionally noted that the reference numerals in the claims should not be interpreted in a way which limits the scope of the claims.

What is claimed is:

1. A system (1) for supplying fuel to an internal combustion engine (3), the system (1) comprising:
a first fuel pump (11) for delivering fuel (7) from a reservoir (9) to the internal combustion engine (3);
a suction jet pump (15) for filling the reservoir (9) with fuel (7);
a second fuel pump (13) for operating the suction jet pump (15); and
a control unit (25)) for operating the second fuel pump (13) if a fuel fill level falls below a predefinable threshold value.

2. The system (1) according to claim 1, further comprising:
a first fill level measuring device (27); wherein the first fill level measuring device (27) ascertains the fuel fill level in a fuel tank (5) in which the system (1) is disposed; wherein said first fuel level measuring device (27) transmits the ascertained fuel fill level to the control unit (25).

3. The system (1) according to claim 2, additionally comprising:
a second fill level measuring device (29); wherein the second fill level measuring device (29) ascertains the fuel fill level in the reservoir (9); wherein said second fill level measuring device (29) transmits the ascertained fuel fill level to the control unit (25).

4. The system (1) according to claim 3, wherein the second fill level measuring device (29) is a contact switch.

5. The system (1) according to claim 3, wherein at least one of the first fill level measuring device (27) and the second fuel fill level measuring device (29) continuously ascertains the fuel fill level.

6. The system (1) according to claim 1, wherein the control unit (25) compares the fuel fill level with the predefinable threshold value.

7. The system (1) according to claim 1, wherein the control unit (25) is an engine control device.

8. The system (1) according to claim 1, wherein the control unit (25) is a pump control device.

9. A method for operating the system (1) according to claim 1, the method comprising the following steps: actuating the first fuel pump (11) for the delivery of fuel (7) from the reservoir (9) to the internal combustion engine (3); ascertaining the fuel fill level and comparing said fuel fill level with the predefinable threshold value using the control unit (25); and actuating the second fuel pump (13) for operating the suction jet pump (15) if the fuel fill level lies below the threshold value.
